(19) United States
(12) Patent Application Publication
(10) Pub. No.: US 2010/0132049 A1
(43) Pub. Date: May 27, 2010

(54) LEVERAGING A SOCIAL GRAPH FROM A SOCIAL NETWORK FOR SOCIAL CONTEXT IN OTHER SYSTEMS

(75) Inventors: Michael Steven Vernal, San Francisco, CA (US); Wei Zhu, Cupertino, CA (US); James M. Leszczenski, Sunnyvale, CA (US); Joshua E. Elman, Mountain View, CA (US); David Brookes Morin, San Francisco, CA (US); Charles Duplain Cheever, Palo Alto, CA (US); Ruchi Sanghvi, Palo Alto, CA (US); Julie Zhuo, Palo Alto, CA (US); Luke Jonathan Shepard, San Francisco, CA (US)

Correspondence Address: Facebook/Fenwick;Silicon Valley Center, 801 California Street, Mountain View, CA, 94041, US

(73) Assignee: FACEBOOK, INC., Palo Alto, CA (US)

(21) Appl. No.: 12/324,761

(22) Filed: Nov. 26, 2008

(51) Int. Cl. G06F 21/20; G06Q 99/00

(52) U.S. Cl. 726/27; 705/319

(57) ABSTRACT

A social network contains information describing information about members of the social network and about various connections among the members. An external system that interacts with users (such as a website) communicates with the social network to access information about the members of the social network. In particular, the external system may determine whether a user is a member of the social network and then obtain information about the member and the member's connections within the social network. This allows an external system to use information from the social network to enhance a user's experience on the external system, while enforcing each member's privacy settings.

### FIELD OF THE INVENTION

This invention relates to social networking and in particular to using information from a social network in an external system outside of the social network.

### BACKGROUND

A system such as a website that allows users to interact with the system typically stores a record for each of the users of the system. Such representation of a user may comprise information provided by the user as well as information related to past activities of the user on the website. For example, a website may require a user to enter information such as contact information, gender, preferences, interests, and the like in an initial interaction with the website. The website may use the information provided to make subsequent interactions with the user more efficient and beneficial to both the user and the website. Also, websites attempt to make an interaction with a user personalized to the user by displaying information that the user can relate to. For example, a user's interests may be used by the website to target advertisements that are of interest to the user. Similarly, past interactions of the user with the system also provide information that can be used by the website in future interactions. For example, a website selling books may keep track of previous purchases of a user and provide the user with information on related books during subsequent interactions with the website.

However, a typical system lacks information associated with social connections of a user that can be used effectively for promoting products or for making interactions with the user personalized to the user. A user may be interested in looking at products that the user's friends have purchased in the past. Similarly, a user may be interested in knowing about interactions of the user's friends with the system. For example, a user visiting a website that sells books may be interested in books that the user's friends have looked at in the past, reviews provided by the user's friends, comments on forums provided by the user's friends if the website supports a forum, and similar information. Being able to see activities of a user's friends may improve the user experience on a website and increase the chances of the user's visiting the website in future. In addition, presenting a product to a user that has been purchased and liked by the user's friends enables a website to leverage from the credibility of word of mouth advertising.

Typical systems do not possess information related to a user's social circle. Assimilating such information may require the system to interact with a large number of users over extended periods of time. Moreover, vendors that provide a website with a specialized functionality may not have the resources or the expertise needed to build a system that can collect the necessary information required to capture the social aspects of a user.

### SUMMARY

A social network maintains information related to social aspects of its members, and this information may be highly valuable to external systems that do not maintain this information. Embodiments of the invention allow external systems to access information about members of a social network and their connections. The external system may use this information for various purposes, including presenting activities of a user's friends on the external system to the user.

One embodiment presents a computer implemented method for providing information associated with a member of a social network to an external system. The information provided may be associated with the member or with the member's connections. An external system requesting information associated with a member from a social network provides information identifying the member to the social network along with the request. In one embodiment, the information used by an external system to identify a member comprises a hash value based on the email address of the user of the external system. The social network identifies the member based on the information provided in the request from the external system. The social network ensures that the privacy settings of all the members whose information is being requested are respected. A subset of the requested information based on the privacy settings of all the members whose information is requested is provided to the external system. A member who is not allowed to access certain information in the social network is not allowed to access the same information in the external system.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is high-level diagram illustrating how an external website can interact with a social networking website, in accordance with one embodiment of the invention.

FIG. 2 is a diagram of a social networking website, in accordance with an embodiment of the invention.

FIG. 3 is an example diagram of privacy settings of a member of a social network, in accordance with one embodiment of the invention.

FIG. 4 is an interaction diagram of a process in which an external system obtains information about a member of a social network, in accordance with one embodiment of the invention.

FIG. 5 is an interaction diagram of a process in which an external system determines whether a user of the external system is a member of a social network, in accordance with one embodiment of the invention.

FIG. 6 is an interaction diagram of a process in which the external system accesses member profile information of a user of the external system from a social network, in accordance with one embodiment of the invention.

FIG. 7 is an interaction diagram of a process in which the external system accesses information associated with a member's friends from a social network, in accordance with one embodiment of the invention.

FIG. 8 is an example display from an application running on an external system, the display combining information associated with a user's friends obtained from a social network with activities of the user's friends on the external system, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Interactions Between an External System and a Social Network

A social network offers its members the ability to communicate and interact with other members of the social network. In use, members join the social network and then add connections to a number of other members to whom they desire to be connected. As used herein, the term “friend” refers to any other member to whom a member has formed a connection, association, or relationship via the social network. Connections may be added explicitly by a member, for example, the member selecting a particular other member to be a friend, or automatically created by the social network based on common characteristics of the members (e.g., members who are alumni of the same educational institution). Connections in social networks are usually in both directions, but need not be, so the terms “member” and “friend” depend on the frame of reference. For example, if Bob and Joe are both members and connected to each other in the website, Bob and Joe, both members, are also each other's friends. The connection between members may be a direct connection; however, some embodiments of a social network allow the connection to be indirect via one or more levels of connections. Also, the term friend need not require that members actually be friends in real life; it simply implies a connection in the social network.

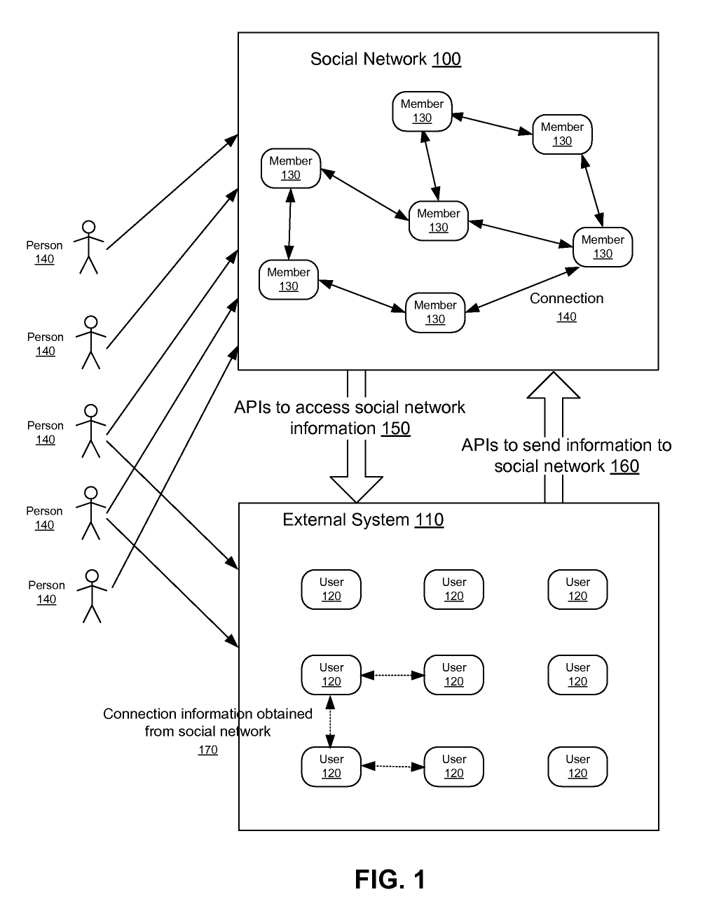

FIG. 1 shows the interaction between an external system 110 and a social network 100, as well as with individuals 140 who may be members 130 of the social network 100 and/or users 120 of the external system 110. The external system 110 may have several users 120 that interact with the system. In particular, a person 140 may be a member 130 of the social network 100 and also a user 120 of the external system 110. The social network 100 keeps a record of information for each member 130 and the connections 140 among the members 130. The record of members 130 and their connections 140 in the social network 100 may be called a “social graph.”

In accordance with embodiment of the invention, the external system 110 can access the information about the social graph using an Application Programming Interface (API) 150 provided by the social network. For example, connection information 170 in the external system 110 represents information obtained from the social network by calling the API 150. The external system 110 may use the information obtained from the social network for various purposes. For example, the external system may present activities of a user's friends on the external system to the user. The external system may also post information related to the user's activities on the social network using the APIs 160 provided by the social network. The information posted on the social network by calling the APIs 160 may be made available to the user's friends on the social network.

A social network provides various mechanisms to its members to communicate with each other and to obtain information about their connection that they might find interesting, such as activities that their friends are involved with, applications that their friends are installing, and comments made by friends on activities of other friends. These mechanisms include email, notifications, newsfeeds and the like. For example, a newsfeed provides to a member, a constantly updated list of activities of the member's friends.

### System Architecture

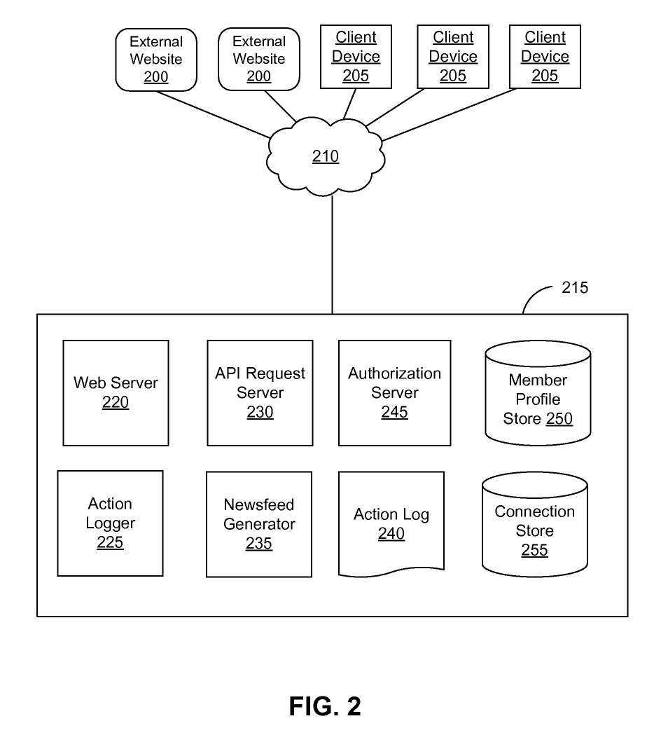

FIG. 2 is a high level block diagram illustrating a system environment suitable for operation of a social networking website 215. The system environment comprises one or more client devices 205, one or more external websites 200, a social networking website 215, and a network 210. In alternative configurations, different and/or additional modules can be included in the system.

The client devices 205 comprise one or more computing devices that can receive member input and can transmit and receive data via the network 210. For example, the client devices 205 may be desktop computers, laptop computers, smart phones, personal digital assistants (PDAs), or any other device including computing functionality and data communication capabilities. The client devices 205 are configured to communicate via network 210, which may comprise any combination of local area and/or wide area networks, using both wired and wireless communication systems.

FIG. 2 contains a block diagram of the social networking website 215. The social networking website 215 includes a web server 220, an action logger 225, an API request server 230, an action log 240, a newsfeed generator 235, a member profile store 250, and a connection store 255. In other embodiments, the social networking website 215 may include additional, fewer, or different modules for various applications. Conventional components such as network interfaces, security mechanisms, load balancers, failover servers, management and network operations consoles, and the like are not shown so as to not obscure the details of the system.

The social networking website 215 comprises a computing system that allows members to communicate or otherwise interact with each other and access content as described herein. The social networking website 215 stores member profiles that describe the members of a social network, including biographic, demographic, and other types of descriptive information, such as work experience, educational history, hobbies or preferences, location, and the like. The website 215 further stores data describing one or more connections between different members in the connection store 255. The connection information may indicate members who have similar or common work experience, group memberships, hobbies, or educational history. Additionally, the social network host site 215 includes member-defined connections between different members, allowing members to specify their relationships with other members. For example, these member defined connections allows members to generate relationships with other members that parallel the members' real-life relationships, such as friends, co-workers, partners, and so forth. Members may select from predefined types of connections, or define their own connection types as needed.

The web server 220 links the social networking website 215 via the network 210 to one or more client devices 205; the web server 220 serves web pages, as well as other web-related content, such as Java, Flash, XML, and so forth. The web server 220 may include a mail server or other messaging functionality for receiving and routing messages between the social networking website 215 and the client devices 210. The messages can be instant messages, queued messages (e.g., email), text and SMS messages, or any other suitable messaging technique.

The API request server 230 allows external websites 200 to access information from the social networking website 215 by calling APIs 150. The API request server 230 may also allow external websites 200 to send information to social networking website by calling APIs 160. An external website 200 sends an API request to the social networking website 215 via the network 210. The API request is received at the social networking website by the API request server 230. The API request server processes the request by calling the appropriate API to collect any appropriate response, which is then communicated back to the external website 200 via the network 210.

The action logger 225 is capable of receiving communications from the web server 220 about member actions on and/or off the social networking website 215. The action logger 225 populates the action log 240 with information about member actions to track them. Any action that a particular member takes with respect to another member is associated with each member's profile, through information maintained in a database or other data repository, such as the action log 240. Such actions may include, for example, adding a connection to the other member, sending a message to the other member, reading a message from the other member, viewing content associated with the other member, attending an event posted by another member, among others. In addition, a number of actions described below in connection with other objects are directed at particular members, so these actions are associated with those members as well. When a member takes an action on the social networking website 215, the action is recorded in an action log 240. In one embodiment, the website 215 maintains the action log 240 as a database of entries. When an action is taken on the website 215, the website 215 adds an entry for that action to the log 240.

The newsfeed generator 235 generates messages for each member about information that may be relevant to the member, based on actions stored in the action log 240. These messages are called “stories”; each story is a message comprising one or more lines of information that describe one more actions in the action log 240 that are relevant to the particular member. The stories are presented to a member via one or more pages of the social networking website 100.

The authorization server 245 enforces the privacy settings of the members of the social network. The privacy setting of a member determines how particular information associated with a member can be shared. The privacy setting comprises the specification of particular information associated with a member and the specification of the entity or entities with whom the information can be shared. The entities with which information can be shared may include other members, applications, external systems, or any entity that can potentially access the information. The information that can be shared by a member comprises member profile information like profile photo, phone numbers associated with the member, member's connections, actions taken by the member such as adding a connection, changing member profile information and the like.

The privacy setting specification may be provided at different levels of granularity. For example, the information to be shared may be specified as specific information, such as, work phone number, or a set of related information, such as, personal information including several pieces of related information including profile photo, home phone number, and status. Alternatively, the privacy setting may apply to all the information associated with the member. The specification of the set of entities that can access particular information can also be specified at various levels of granularity. Various sets of entities with which information can be shared may include, for example, all friends of the member, all friends of friends, all applications, or all external systems. One embodiment allows the specification to comprise an enumeration of entities, for example, the user may provide a list of external systems that are allowed to access certain information. Another embodiment allows the specification to comprise a set of entities along with exceptions that are not allowed to access the information. For example, a member may allow all external systems to access the member's work information but specify a list of external systems that are not allowed to access the work information. Certain embodiments call the list of exceptions that are not allowed to access certain information a block list. External systems belonging to a block list specified by a member are blocked from accessing the information specified in the privacy setting. Note that the various combinations of granularity of specification of information and the granularity of specification of entities with which information is shared are possible, i.e., all personal information may be shared with friends whereas all work information may be shared with friends of friends.

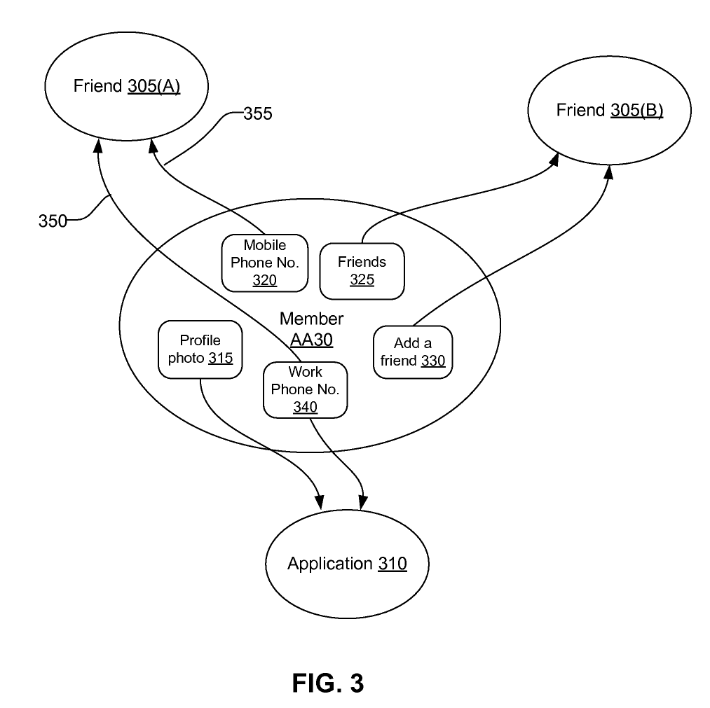

FIG. 3 illustrates an example of how the privacy settings of a member 130 control the accessibility of information associated with the member 130 to the member's friends 305 or applications 310. As shown in FIG. 3, the arrow 350 indicates that friend 305(A) is allowed to access the work phone number 340 of member 130, and arrow 355 indicates that friend 305(A) is allowed to access the mobile phone number of the member 130. Friend 305(A) does not have access to information such as profile photo 315 of the member 130 or the member's friends list 325. On the other hand, friend 305(B) is allowed to access the friends list 325. The information associated with a member includes actions taken by a member such as the action of adding a new friend 330. The member 130 can completely block another member or an application from accessing any information associated with the member 130. A member or an application that is blocked by the member 130 does not have access to any information associated with member 130.

The authorization server 245 contains logic to determine if certain information associated with a member can be accessed by a member's friends and/or other applications and entities. For example, an application 310 that attempts to access a member's work phone number 340 must get authorization to access the information from the authorization server 245. The authorization server 245 decides based on the member's privacy settings if the member's work phone number 340 can be accessed by the application 310. Based on the member's privacy settings, the authorization decides if the application 310 is allowed to access information associated with the member 130.

As discussed above, the social networking website 215 maintains data about objects with which a member may interact on the website 215. To this end, the member profile store 250 and the connection store 255 store instances of the corresponding type of objects maintained by the website 215. Each object type has information fields that are suitable for storing information appropriate to the type of object. For example, the member profile store 250 contains data structures with fields suitable for describing a member's profile. When a new object of a particular type is created, the website 215 initializes a new data structure of the corresponding type, assigns a unique object identifier to it, and begins to add data to the object as needed. This might occur, for example, when a user becomes a member of the website 215, the website 215 generates a new instance of a member profile in the member profile store 250, assigns a unique identifier to the member profile, and begins to populate the fields of the member profile with information provided by the member.

External System Accessing Information from Social Network

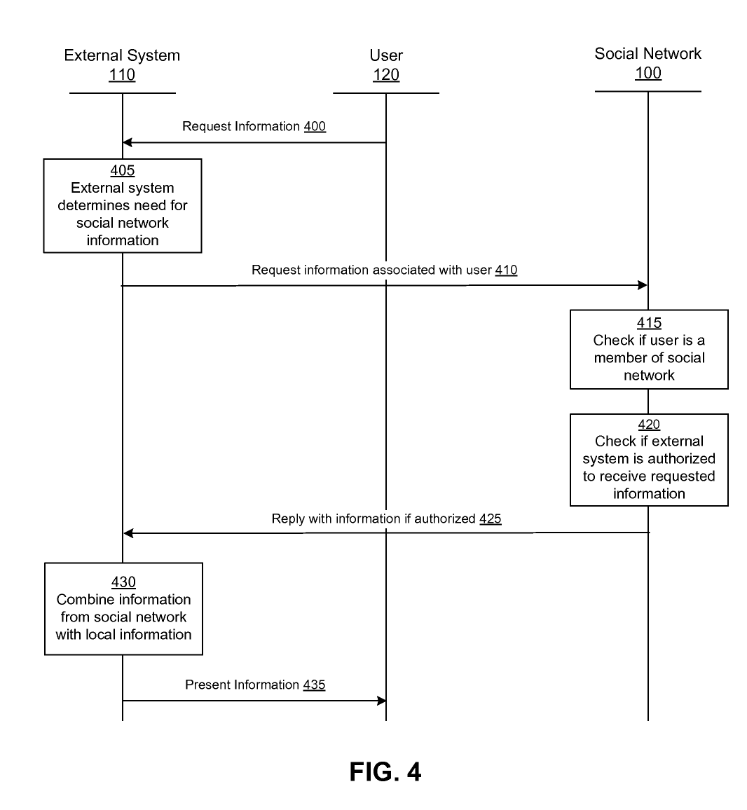

FIG. 4 illustrates a process by which external system 110 accesses information associated with a user 120 from a social network 100. A member 130 of the social network becomes a user 120 of the external system by either creating an account on the external system 110 or by simply interacting with the external system 110. The process of FIG. 4 starts with a user 120 of the external system requesting 400 information from the external system 110. FIG. 4 does not show certain steps that may happen before the user's request 400 to the external system. For example, the user 120 may login to the external system 110 and take other actions before invoking the process that results in the requesting 400 of information from the external system 110. In certain embodiments, the interaction 40 may correspond to the user taking an action on the external system. To respond to the user's request, or to present the user with information that may be of interest to the user, the external system 110 determines 405 a need for information from the social network 100, related to the user 120. For example, a user may interact with a website for donating to a charity. The website may want to present to the user, a list of the user's friends that have donated at the website. Determining the list of user's friends requires the website to interact with the social network 100.

The external system 110 requests 410 information associated with user 120 from the social network 100. The external system 110 may or may not have the information regarding whether the user 120 is a member of the social network 100. In case the external system 110 does not have information about whether the user 120 is a member of the social network 100, the external system may request the membership status of the user 120 in the social network 100. If the external system has the information that the user 120 is a member of the social network 100, the external system may request further information related to user 120 from the social network 100. The additional information requested may comprise details of the member profile of the user or a list of the user's connections in the social network 100.

As part of the request 410, the external system 110 may present information associated with the user 120 that helps the social network 100 identify the user as a member of the social network. The information presented by the external system for identifying the member 130 may depend on previous communications between the external system 110 and the social network 100 regarding the user 120. For example, if the external system 110 has previously communicated with the social network 100 regarding user 120, the external system 110 may have a unique identifier associated with the user's member profile, which may then be used to identify the member uniquely. If this is the first request sent by the external system 110 to the social network 100 regarding the user 120, the external system 110 may send information useful for identifying the user 120. In one embodiment, the external system 110 may uniquely identify the user 120 by sending information that it maintains for the user 120, such as the user's full name, email address, home phone number, date of birth, or any other identifying information, alone or in combination. In certain embodiments, the external system 110 may compute a hash value based on information useful for identifying the user 120 and send the hash value to the social network 100. Use of a hash function on the user's unique information beneficially protects the user's privacy and generally enhances the security of the communications between the external system 110 and the social network 100

Once the request 410 is received by the API request server 230 of the social network 100, in certain embodiments, the API request server 230 checks 415 the member profile store 250 to determine whether the identification information presented with the request matches a member of the social network 100. If the identification information matches a member of the social network 100, the API request server 230 communicates with the authorization server 245 to check 420 if the member has authorized the external system 110 to access the requested information. If the requested information is associated with multiple members of the social network, the privacy settings of all the members involved are checked to compute the subset of information that the external system is authorized to access. The information returned to the external system includes only the subset of information that the external website is authorized to access based on the privacy settings of all the members whose information is requested. A member who is not allowed to access certain information in the social network is not allowed to access the same information when the social network information is presented to the member in an external system.

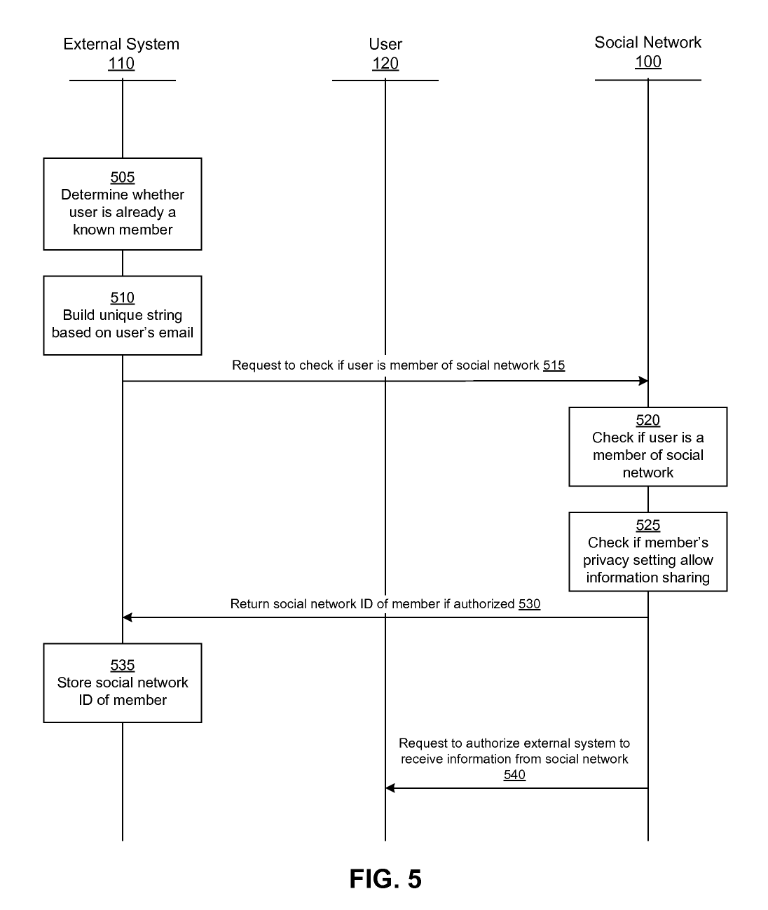

If the external system 110 is authorized to access the requested information, the social network 100 replies 425 to the external system's request 410 with the requested information. The processes of requesting 410, checking 420, and replying 425 may repeat several times, until the external system 110 has obtained the information that it needs for its own purposes. FIGS. 5, 6, and 7 present various embodiments of the interactions between the user 120, external system 110, and the social network 100 for particular types of information requests. Once the external system 110 gets the information it requested, it may then combine 430 the information obtained from the social network 100 with information available in the external system 110 for any of a variety of purposes intended by the external system 110. The external system 110 then presents 435 this combined information to the user 120.

FIG. 5 shows a process by which an external system 110 checks if a user 120 of the external system 110 is a member 130 of the social network 100. The process starts when the external system determines that it needs to know whether the user 120 is a member of the social network 100. If so, the external system may first determine 505 whether the external system 110 already knows that the user 120 is a member of the social network 100. In certain embodiments, if the external system 110 has previously learned that the user 120 is a member and has stored that information this process can stop. Otherwise, the external system 110 needs to request this information from the social network 100.

In one embodiment, the social network 100 provides an API 150 to allow the external system 110 check if a user is a member of the social network 100. This API can take as an input a string that uniquely identifies the member based on information associated with the member. In response, the API can return a Boolean value that is true if the user is a member of the social network, false otherwise. In another embodiment, the API can return a unique identifier for the member, which the external system 110 may use to identify the member for subsequent requests to the social network 100. Other embodiments may take a different set of arguments and/or return the result in a different format.

In one embodiment, the external system 110 builds 510 a unique string based on unique information about the user. This unique string may comprise a hash string based on the email address or other unique information associated with the user 120 of the external system 110. Using the unique string to identify the user 120, and the API described above, the external system requests 515 that the social network 100 inform it whether the user 120 is a member. The API request server 230 receives this request and checks 520 against the member profile store 250 to see if the input identification string matches the member profile of a member of the social network. In an embodiment where the string has been hashed, the server 230 may apply an inverse hash function to obtain the original unique identifier for the user 120. In another embodiment when a hash value is provided as input to an API, the server 230 may compare the input hash value with a predetermined hash value stored with the member profile. The determined hash value is computed using the same mechanism as used by the external system 110.

If the identification string provided does not match any member of the social network, a reply 530 to the external system 110 is sent indicating the result of the API call is the Boolean value false. If the identification string provided matches a member of the social network 100, the API request server 230 checks 525 with the authorization server 245 to determine if the identified member's privacy settings allow sharing of the member's status with the external system 110. The result of this determination is then returned 530 to the external system 110. If the member has blocked the external system 110 from getting information about the member, the Boolean value false is returned to the external system 110 by the API request server 230, even though the user is a member of the social network 100. In certain embodiments, the external system 110 has no mechanism to deduce that the user 120 is a member when the external system 110 is not authorized to access that information. If the member has not blocked the external system 110, the Boolean value true is returned to the external system by the API request server 230.

When the user 120 is a member of the social network 100 and has not blocked the external system 110, the social network 100 may return 530 to the external system 110 a member ID associated with the user 120. This member ID is used by the social network 100 to identify the member uniquely. The member ID may be returned as part of the reply 530 or provided as a result of a separate API call. The member ID associated with the user is then stored 535 by the external system 110, optionally along with other information associated with the user 120. The member ID may be used for identifying the user 120 in subsequent requests sent to the social network 100. The ability to use the member ID in an API call may improve performance compared to an API that requires the external system 120 to build a unique ID string from information associated with the member.

In the event that the user 120 is a member of the social network 100 but has not yet authorized access by the external system 110 (e.g., in an embodiment that requires an opt-in to the sharing), the social network 100 may request 540 the user 120 to authorize the social network 100 to share the user's information with external systems in the future. This request 540 may identify the external system 110 that attempted but failed to determine whether the user 120 is a member of the social network 100. The request 540 may also describe how the member can authorize the external system 110 to access the member's information from the social network 100 by logging into the social network 100 and providing the necessary credentials (such as username and password). A member that authorizes sharing of the member's information may prevent the external system 110 from accessing specific parts of the member's information by changing the member's privacy settings, as explained above.

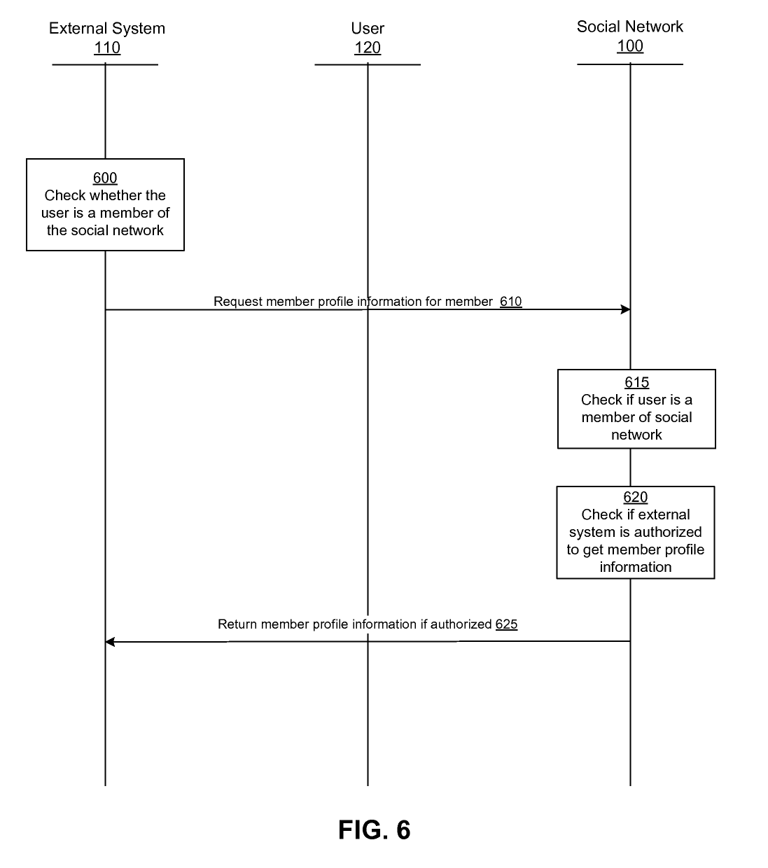

FIG. 6 shows a process in which an external system 110 obtains information about a member's profile from the social network 100. The information requested may include personal information, such as a picture of the user 315, a mobile phone number 320, a work phone number 340, status information, or any other suitable personal information. In certain embodiments, the external system may request information related to actions taken by the user, for example, the user adding a friend 330. When the external system 110 determines that it needs particular information about the user's member profile in the social network 100, the external system 110 checks 600 the information associated with the user stored at the external system 110 to determine if the user is a member of the social network 100. If the external system 110 has information indicating the user is not a member of the social network 100, this process may stop. Alternatively, the external system 110 may check with the social network 100 (e.g., as described in FIG. 5) to confirm if the user has become a member of the social network 100 since the last time the external system 110 checked.

If the external system 110 determines that the user is a member of the social network 100, the external system 110 sends a request 610 to the social network 100. In one embodiment, the request 610 comprises a call to an API 150, which is received by the API request server 230. The API 150 may require inputs that identify the user as a member of the social network 100, e.g., using the member ID described above. Based on the identification information provided with the request 610, the social network 100 checks 615 if the user is a member of the social network 100. If the user is a member of the social network 100, the API request server 230 checks 620 with the authorization server 245 to determine if the identified member has authorized the external system 110 to access the requested information. If the user has authorized the external system 110 to access the requested information, the requested information is returned 625 as the reply to the request 610.

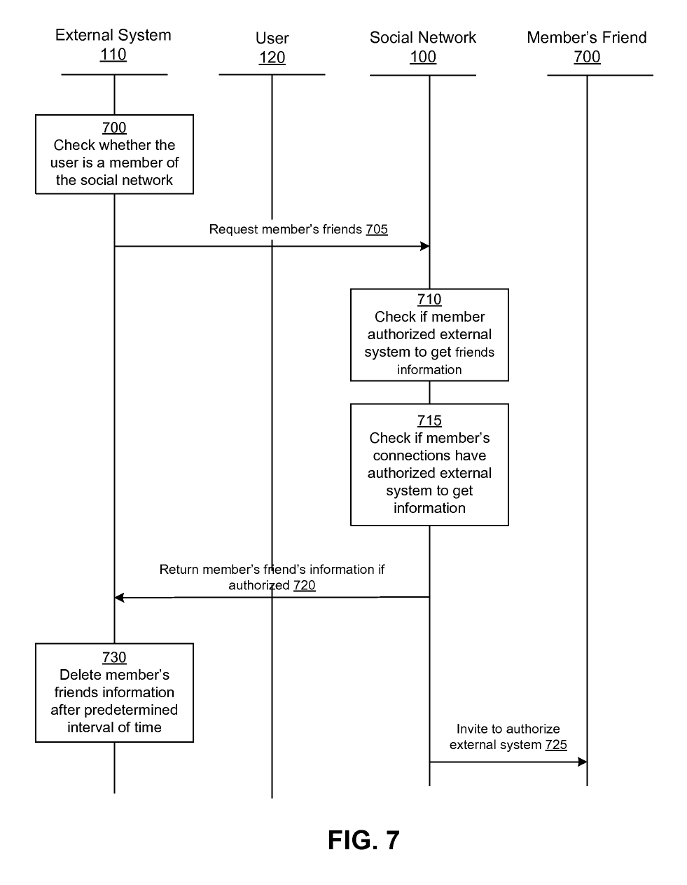

FIG. 7 shows a process by which an external system 110 obtains information about a member's connections in the social network 100. When the external system 110 determines that it needs particular information about the user's connections in the social network 100, the external system 110 may determine 700 whether the user is a member of the social network 100 and respond accordingly, as described above in connection with step 600.

In response to a request that requires information associated with multiple members of the social network, the privacy settings of all the members concerned are analyzed to determine what information can be provided to the external system 110. For example, in response to a request of information related to a member's connections, the privacy settings of the user as well as the privacy settings of the member's connections are analyzed to determine the information communicated to the external system 110. If the user 120 is a member of the social network 100, the external system 110 sends a request 705 to the social network 100 with the appropriate information to identify the user 120. The API request server 230 receives this request and checks with the authorization server 245 to determine if the identified member has authorized the external system 110 to access the member's connection list. If the member has authorized the external system 110 to access the member's connection list, the social network 100 checks 715 the authorization server 245 to determine if each connection (i.e., the other member identified by the connection) on the member's connection list has also authorized the external system 110 to access the connection's information.

In one embodiment, the user may have given access to the external system to obtain information associated with the user's friends of the friends. This allows the external system to get the list of all the friends of the user as well as all the friends of each friend of the user. However, a friend X of the user may allow the external system to access X's information but may not allow access to X's friends list. The final list communicated to the external system includes X but does not include X's friends. Another friend Y may not allow the external system access to any of Y's information. The final list communicated to the external system would thus not include Y, or any of Y's friends.

If the privacy settings of both the member and one or more of the member's connections allow for the sharing, the social network 100 replies 730 to the external system 110 with a list of the member's connections that have authorized the external system 110 to access this information. The external system 110 may be allowed to store the connections list of the user 120, or the external system 110 may be required (e.g., by the social network 100) to delete the connections list of the user 120 after a predetermined interval of time. If the external system 110 is required to delete the connections list of the user 120 after a predetermined interval of time, the external system 110 may have to send another request 705 after the predetermined interval has passed to fetch the connections list for the social network 100 if needed.

In one embodiment, if any of the member's connections have not authorized access by the external system 110, the social network 100 may invite 725 those connections to authorize access to their information. Alternatively, this invitation may be sent on behalf of or directly by the member associated with user 110. A member that receives a request from a friend asking him to authorize an external system 110 may be more likely to accept the request than a member receiving a request from the external system 110 directly or from another source that the member may not trust.

In certain embodiments, the external system receives information associated with a user from the social network and combines it with information from the external system to present to the user. In an alternative embodiment, the social network may require the external system to provide information associated with various members' actions taken on the external system on a regular basis, and the social network processes the information to generate newsfeeds containing relevant information. The external system may call APIs of the social network that allow the external system to retrieve processed information such as the newsfeed for a particular user. The external system may send a request for the newsfeed information of a user, identifying the user as well as the external system. The social network computes the newsfeed information to be sent to the external system in a reply by filtering only the newsfeed information from users that have authorized the external system to receive the requested information. The social network also filters out the newsfeed information related to other external systems.

### Application Combining External System and Social Network Information

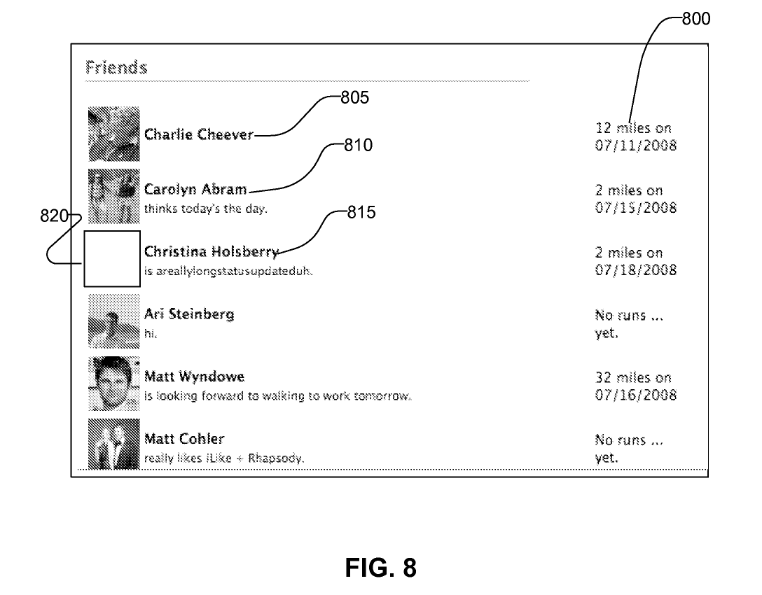

FIG. 8 shows an example of an external system that combines information associated with its users obtained from the social network with information collected by the external system. In this example, the external system allows users to log in and track their running history, as well as view the running histories of their friends on the social network. More specifically, the example system includes an application that allows users to record information 800 associated with how far they ran on a particular date. The application presents information to a user that logs into the external system. Since the user of the system records how many miles the user ran on different days, it is likely the user is interested in knowing if any of the user's friends are also recording their information on the external system. Also, the user may like to know information associated with how far the user's friends ran on certain dates.

The application obtains the user's friends list from the social network, assuming the user has authorized the application and the external system to get the required information. Note that any friend of the user that has blocked the external system or the application is not presented by the application in FIG. 8. The application also presents information such as status information and profile photo of members from the social network. A member 805 may not have made the status information available to the social network or may have prevented the external system from accessing the status information. Similarly, user 815 may have either not provided a profile photo 820 to the social network or may have prevented the external system from accessing the user's profile photo from the social network.

Other applications from different domains may similarly provide various functionalities that leverage the social graph information contained in the social network. For example, an external system implementing an online bookstore may present a user with information related to the user's friends that buy books from the bookstore or books that have been purchased by the user's friends. This information may be filtered based on information from the member's profile, for example, a user that lists cooking as a hobby as part of the member profile on the social network may be presented with cookbooks that the user's friends may have purchased from the bookstore. This presents a mechanism for external systems to present information that they are very likely to be interested in. For example, knowing a member's hobbies allows the external system to filter out information that may not be of interest to the user.

Presenting the above information when the user logs into the external system is the most appropriate time, since the user is prepared to look for relevant information and is actively looking for relevant information. Presenting the information associated with an external system at other times may not have as much impact since the user may be busy with other activities not related to the external system and may not pay attention to matters related to the external system. Also, being able to provide the information relevant to the external system in the context of the member's friends provides credibility to the information presented. For example, a user is more likely to be influenced to respond to a message in the presence of information that the member's friends have taken certain action on the external system.

### Alternative Applications

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method for providing information associated with a member of a social network, the method comprising:
receiving a request from an external system for information associated with a user of the external system, wherein the request contains information identifying the user;
identifying a member of the social network based on the information identifying the user;
determining if the external system is authorized to receive the information requested in the message; and
sending a reply to the external system comprising a subset of the requested information, wherein the subset comprises requested information that the external system is authorized to access.

2. The method of claim 1, wherein the information identifying the user comprises a hash value based on the email address of the user of the external system.

3. The method of claim 1, wherein the information requested by the external system comprises whether the user of the external system is member of the social network.

4. The method of claim 3, wherein the reply informs the external system that the user is not a member of the social network if the user is a member of the social network who has blocked the external system from accessing the user's information.

5. The method of claim 1, wherein the information requested by the external system comprises member profile information of the identified member and determining if the external system is authorized to access the information comprises checking if the identified member has authorized the external system to access the requested member profile information.

6. The method of claim 1, wherein the information requested by the external system comprises a friend's list of the identified member and determining if the external system is authorized to access the information comprises checking if the identified member has authorized the external system to access the member's friend's list and the subset of requested information sent in the reply comprises a subset of the friend's list based on friend's that have authorized the external system to access their information.

7. The method of claim 6, further comprising:
sending an authorization request to a friend in the identified member's friend's list that has not authorized the external system to access the friend's information.

8. The method of claim 6, wherein the information requested by the external system comprises activities of the friends of the identified member on the external system, the method further comprising:
receiving information related to actions taken by users on one or more external systems.

9. A computer program product for providing information associated with a member of a social network, the computer program product comprising a computer-readable storage medium containing computer program code for:
receiving a request from an external system for information associated with a user of the external system, wherein the request contains information identifying the user;
identifying a member of the social network based on the information identifying the user;
determining if the external system is authorized to receive the information requested in the message; and
sending a reply to the external system comprising a subset of the requested information, wherein the subset comprises requested information that the external system is authorized to access.

10. The computer program product of claim 9, wherein the information identifying the user comprises a hash value based on the email address of the user of the external system.

11. The computer program product of claim 9, wherein the information requested by the external system comprises whether the user of the external system is member of the social network.

12. The computer program product of claim 11, wherein the reply informs the external system that the user is not a member of the social network if the user is a member of the social network who has blocked the external system from accessing the user's information.

13. The computer program product of claim 9, wherein the information requested by the external system comprises member profile information of the identified member and determining if the external system is authorized to access the information comprises checking if the identified member has authorized the external system to access the requested member profile information.

14. The computer program product of claim 9, wherein the information requested by the external system comprises a friend's list of the identified member and determining if the external system is authorized to access the information comprises checking if the identified member has authorized the external system to access the member's friend's list and the subset of requested information sent in the reply comprises a subset of the friend's list based on friend's that have authorized the external system to access their information.

15. The computer program product of claim 14, the computer-readable storage medium further containing computer program code for:
sending an authorization request to a friend in the identified member's friend's list that has not authorized the external system to access the friend's information.

16. The computer program product of claim 14, wherein the information requested by the external system comprises activities of the friends of the identified member on the external system, the computer-readable storage medium further containing computer program code for:
receiving information related to actions taken by users on one or more external systems.

17. A computer implemented method for receiving information associated with a member of a social network by an external system, the method comprising:
sending a request for information associated with a user of an external system, wherein the request is sent to a social network and comprises information identifying the user;
receiving a reply comprising a subset of the requested information wherein the reply is received from a social network and the subset of the requested information comprises requested information that the external system is authorized to access from the social network; and
presenting the information received in the reply along with information available at the external system.

18. The method of claim 17, wherein the information requested by the external system comprises member profile information of the identified member.

19. The method of claim 17, wherein the information requested by the external system comprises a friend's list of the identified member, the method further comprising:
sending a second request to the social network for the friend's list of the user if the external system needs the friend's list after a predetermined interval of time.

20. The method of claim 17, wherein the information requested by the external system comprises activities of the friends of a user of the external system, wherein the activities are associated with the external system, the method further comprising:
sending information related to actions taken by users on the external system to the social network.
